(19) United States
(12) Patent Application Publication
(10) Pub. No.: US 2015/0041270 A1
(43) Pub. Date: Feb. 12, 2015

(54) LOWER SHOCK-ABSORBING APPARATUS FOR WASHING MACHINE PACKING

(71) Applicant: SAMSUNG ELECTRONICS CO., LTD., Suwon-si (KR)

(72) Inventors: Bong Kook BAE, Gwacheon-si (KR); Wan Gi PARK, Suwon-si (KR); Ji Hoon CHOI, Hwaseong-si (KR); Hoon WEE, Yongin-si (KR)

(21) Appl. No.: 14/453,973

(22) Filed: Aug. 7, 2014

(30) Foreign Application Priority Data
Aug. 8, 2013 (KR) 10-2013-0094067

(51) Int. Cl. F16F 7/12

(52) U.S. Cl. CPC F16F 7/12
USPC 188/377

(57) ABSTRACT

Disclosed is a lower shock-absorbing apparatus for washing machine packing that supports and protects a washing machine to prevent damage to the washing machine during transportation of the washing machine. The lower shock-absorbing apparatus includes a cap mounted at a drive shaft mounted to a washing tub to rotate the washing tub, a reinforcement guide to receive the cap, and a lower cushion disposed below the washing tub to absorb shock applied to the washing tub and to receive the reinforcement guide.

### CROSS-REFERENCE TO RELATED APPLICATIONS

This application claims the benefit of Korean Patent Application No. 10-2013-0094067, filed on Aug. 8, 2013 in the Korean Intellectual Property Office, the disclosure of which is incorporated herein by reference.

### BACKGROUND

1. Field

Embodiments of the present disclosure relate to a lower shock-absorbing apparatus for washing machine packing that supports and protects a washing machine to prevent damage to the washing machine during transportation of the washing machine.

2. Description of the Related Art

A washing machine is an apparatus which removes contaminants from the laundry using detergent and water. Based on how laundry is washed, a washing machine may be classified as an agitator washing machine, a pulsator washing machine, or a drum washing machine. The agitator washing machine rotates an agitator extending upward from the center of the bottom of a washing tub in alternating directions to perform washing. The pulsator washing machine performs washing using frictional force between laundry and a water current generated by rotating a disk-shaped pulsator formed at the bottom of a washing tub in alternating directions. The drum washing machine performs washing by rotating a drum having a plurality of lifers protruding from the inner circumference thereof in a state in which water, detergent, and laundry are contained in the drum.

Based on the form thereof, a washing machine may be classified as a top loading washing machine or a front loading washing machine. The top loading washing machine is a washing machine configured such that laundry is introduced into a washing tub through an opening provided at the top thereof. The front loading washing machine is a washing machine configured such that laundry is introduced into a washing tub through an opening provided at the side thereof. The agitator washing machine and the pulsator washing machine belong to the top loading washing machine and the drum washing machine belongs to the front loading washing machine.

In the top loading washing machine, a washing tub is provided in a case of the washing machine and a drive unit is provided below the washing tub to rotate the washing tub. The washing tub is rotated by the drive unit. Since the washing tub is movably provided in the case, the washing tub may shake in the case during transportation of the packed washing machine. When the washing tub shakes in the case, the washing tub collides with the case. As a result, the external appearance of the washing machine may be deteriorated and noise may be generated. In addition, the drive unit disposed below the washing tub may be damaged.

For this reason, after the washing machine is manufactured, the washing machine may be packed using a shock-absorbing packing apparatus. The shock-absorbing packing apparatus may be provided at the front of the washing machine. Another shock-absorbing packing apparatus may be provided at the lower part of the washing machine to fix the washing tub, thereby preventing movement of the washing tub.

A saddle configured to surround the drive unit provided below the washing tub is provided to protect the drive unit. A lower shock-absorbing apparatus is provided below the washing tub. The lower shock-absorbing apparatus is provided with a predetermined receiving part, in which the saddle is located. The receiving part may be provided with a guide corresponding to the shape of the receiving part such that the saddle is located in the guide. Since the saddle is located in the receiving part of the lower shock-absorbing apparatus provided below the washing tub as described above, the washing tub is fixed, thereby preventing movement of the washing tub.

The saddle is made of a material exhibiting sufficient durability to endure external shock. For example, metal may be formed into a U shape to manufacture the saddle. The manufactured saddle is mounted to the lower part of the washing tub using fixing members.

In a case in which the washing tub is fixed using the saddle as described above, a process of fixing the saddle to the lower part of the washing tub is included, whereby a manufacturing process is complicated. In addition, the metal saddle is not necessary after installation of the washing machine, whereby material costs are increased.

### SUMMARY

It is an aspect to provide a lower shock-absorbing apparatus for washing machine packing, wherein a cap, which is inserted into the lower shock-absorbing apparatus, is mounted and fixed to a drive shaft of a drive unit provided below a washing tub, thereby preventing movement of the washing tub during transportation of the packed washing machine.

Additional aspects will be set forth in part in the description which follows and, in part, will be obvious from the description, or may be learned by practice of the invention.

In accordance with an aspect, a lower shock-absorbing apparatus for washing machine packing includes a cap mounted at a drive shaft mounted to a washing tub to rotate the washing tub, a reinforcement guide to receive the cap, and a lower cushion disposed below the washing tub to absorb shock applied to the washing tub and to receive the reinforcement guide.

The reinforcement guide may be provided with a cap receiving part corresponding to an external shape of the cap and the cap may be received in the cap receiving part such that the washing tub is fixed, thereby preventing movement of the washing tub.

The reinforcement guide may include a base mounted at the lower cushion and a support protruding upward from the base, the support being provided with a cap receiving part to receive the cap.

A height from a top of the base to a top of the support may gradually decease from an outer edge of the support to an inner edge of the support on the cap receiving part side such that the cap slides along a top of the reinforcement guide by weight of the washing tub and is inserted into the cap receiving part.

The cap may be provided at one side thereof with a drive shaft insertion hole, into which the drive shaft is inserted.

The cap may be provided at an inside thereof defining the drive shaft insertion hole with a thread and the thread formed at the inside of the cap may move along a thread formed at an outside of the drive shaft such that the cap is mounted to the drive shaft.

The cap may have an inclined outside.

The cap may be configured such that a diameter in section of a lower end of the cap is less than a diameter in section of an upper end of the cap.

The cap receiving part formed at the reinforcement guide may be configured such that a diameter of the cap receiving part on an inlet side is greater than a diameter of a lower end of the cap receiving part so as to correspond to an external shape of the cap.

The cap may be formed in a cylindrical shape and the cylindrical cap may be received in the cap receiving part.

The lower cushion may be manufactured by foaming polystyrene or polypropylene.

The cap or the reinforcement guide may be manufactured by injection-molding plastic.

The lower cushion may include a location part, at which a bottom of the washing machine is located, and a side support protruding upward from an edge of the location part such that the side support comes in surface contact with a portion of a lower outside of the washing machine.

The location part may be provided with a middle support protruding upward and the middle support may be provided with a receiving part to receive the reinforcement guide.

The reinforcement guide may be provided at an outside thereof with a fixing rib and the fixing rib may be forcibly inserted into the lower cushion such that the reinforcement guide is mounted at the lower cushion.

In accordance with an aspect, a lower shock-absorbing apparatus for washing machine packing includes a cap mounted at an end of a drive shaft connected to a washing tub, a reinforcement guide having a cap receiving part corresponding to a shape of the cap, and a lower cushion to receive the reinforcement guide, wherein the cap is formed in a cylindrical shape in which a diameter in section of an upper end of the cap is greater than a diameter in section of a lower end of the cap and the cap is received in the cap receiving part to prevent movement of the washing tub.

The reinforcement guide may have an inclined top such that the cap slides along the inclined top of the reinforcement guide and is inserted into the cap receiving part.

The reinforcement guide may be provided at an outside thereof with a plurality of fixing ribs and the fixing ribs may be forcibly inserted into the lower cushion such that the reinforcement guide is mounted at the lower cushion.

The lower shock-absorbing apparatus may further include a shock-absorbing member disposed between the cap and an inside of the reinforcement guide defining the cap receiving part.

The lower cushion may be provided with a middle support protruding upward and the reinforcement guide may be fixed to the middle support such that shock applied to a lower part of the washing tub is transmitted to the lower cushion via the drive shaft, the cap, and the reinforcement guide to absorb the shock applied to the washing tub.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view showing a washing machine according to an embodiment;

FIG. 2 is a side sectional view of the washing machine according to the embodiment;

FIG. 3 is a perspective view showing the washing machine according to the embodiment and a lower shock-absorbing apparatus;

FIG. 4 is a side view showing the washing machine according to the embodiment and the lower shock-absorbing apparatus;

FIG. 5 is a side sectional view showing a state in which the lower shock-absorbing apparatus is mounted at the washing machine according to the embodiment;

FIG. 6 is a partial side sectional view showing a state in which the lower shock-absorbing apparatus is mounted at the washing machine according to the embodiment;

FIG. 7 is a sectional view showing a lower shock-absorbing apparatus for washing machine packing according to an embodiment;

FIG. 8 is an exploded perspective view of a movement preventing device according to an embodiment;

FIG. 9 is a perspective view showing a cap of the movement preventing device according to the embodiment;

FIG. 10 is a perspective view showing a reinforcement guide of the movement preventing device according to the embodiment;

FIG. 11 is a sectional view showing a lower shock-absorbing apparatus for washing machine packing according to an embodiment;

FIG. 12 is an exploded perspective view of a movement preventing device according to an embodiment;

FIG. 13 is a perspective view showing a cap of the movement preventing device according to the embodiment;

FIG. 14 is a perspective view showing a reinforcement guide of the movement preventing device according to the embodiment; and

FIG. 15 is a sectional view of a reinforcement guide according to an embodiment.

### DETAILED DESCRIPTION

Reference will now be made in detail to the embodiments, examples of which are illustrated in the accompanying drawings, wherein like reference numerals refer to like elements throughout.

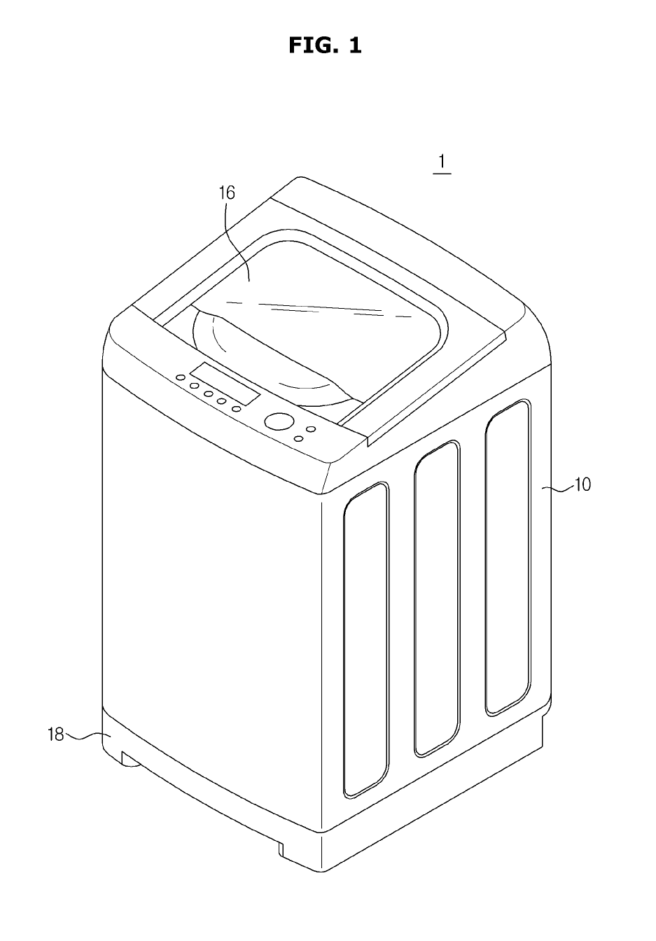

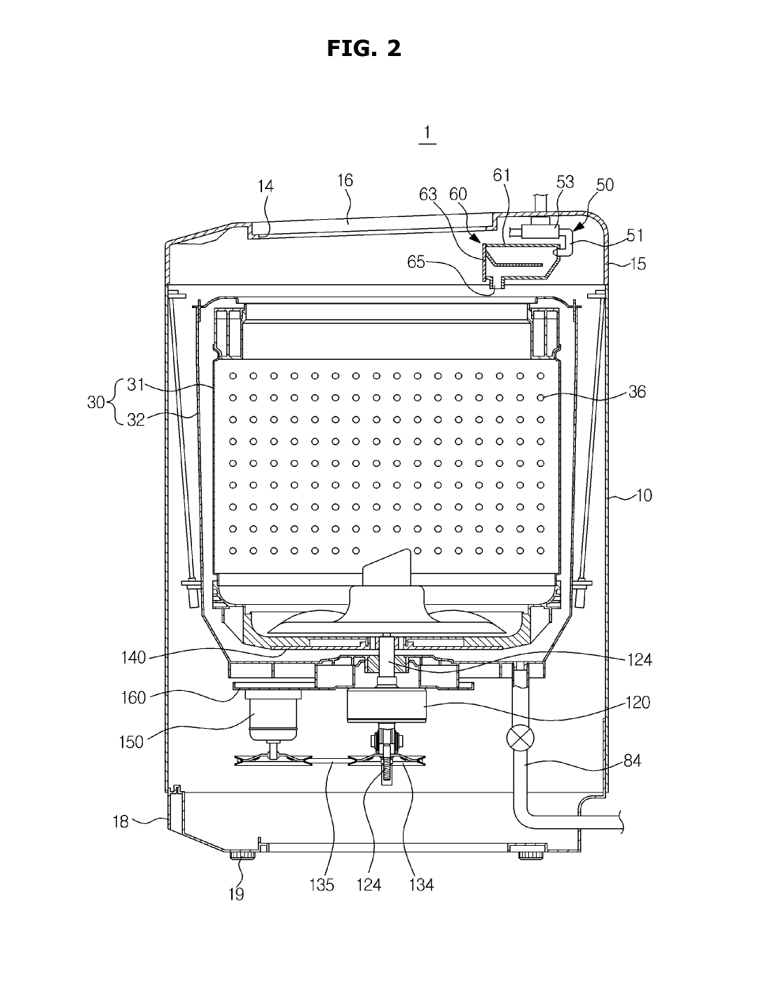

FIG. 1 is a view showing a washing machine according to an embodiment and FIG. 2 is a side sectional view of the washing machine according to the embodiment.

Referring to FIGS. 1 and 2, the washing machine 1 includes a cabinet 10, a washing tub 30, and a drive unit. The cabinet 10 forms the external appearance of the washing machine 1. The washing tub 30 is disposed in the cabinet 10. The washing tub 30 includes an inner tub 31 and an outer tub 32. The inner tub 31 may be rotatably disposed. The drive unit may be disposed below the washing tub 30 to rotate the inner tub 31.

A top cover 15 having a laundry introduction port 14, through which laundry is introduced into the washing tub 30, may be provided at the top of the cabinet 10. A door 16 to open and close the laundry introduction port 14 may be provided at the top cover 15.

A bottom cover 18 may be provided at the bottom of the cabinet 10. Supports 19 to support the washing machine 1 on the floor are coupled to the bottom cover 18 are coupled support. A suspension unit (not shown) to suspend the washing tub 30 may be connected to the upper part of the cabinet 10.

The inner tub 31 may be rotatably disposed in the cabinet 10. The inner tub 31 may be provided at the circumference thereof with a plurality of through holes 36. A pulsator 35 may be rotatably mounted at the bottom of the inner tub 31. The pulsator 35 functions to agitate laundry introduced into the inner tub 31 together with wash water.

The outer tub 32 may be disposed outside the inner tub 31 to surround the inner tub 31. Wash water may be stored in the outer tub 32. The inner tub 31 may be rotated in the outer tub 32 by the drive unit.

A water supply device 50 may be mounted above the washing tub 30. The water supply device 50 may supply wash water into the washing tub 30. The water supply device 50 includes a water supply valve 53 to control the supply of water and a water supply pipe 51 connected between the water supply valve 53 and a detergent supply device 60. One side of the water supply pipe 51 may be connected to an external water supply source (not shown) and the other side of the water supply pipe 51 may be connected to the detergent supply device 60.

The detergent supply device 60 includes a case 61 and a detergent container 63. The case 61 may be provided in the top cover 15. The detergent container 63 may be detachably mounted in the case 61 to store detergent. A discharge port 65 to discharge wash water having detergent dissolved therein may be formed at the bottom of the case 61. Water supplied through the water supply pipe 51 may be supplied into the washing tub 30 together with detergent via the detergent supply device 60.

A first drainage hose 82 and a second drainage hose 84 may be provided below the washing tub 30. Upon completion of a washing or spin-drying cycle, the first drainage hose 82 and the second drainage hose 84 guides wash water out of the cabinet 10.

The drive unit includes a clutch 120, a drive motor 150, a flange member 140, a base plate 160. The clutch 120 may selectively rotate the inner tub 31 and the pulsator 35. The drive motor 150 drives the clutch 120. The flange member 140 is connected between a drive shaft 124 of the clutch 120 and the bottom of the inner tub 31 to transmit rotational force of the drive shaft 124 to the inner tub 31. The base plate 150 may fix the clutch 120 and the drive motor 150.

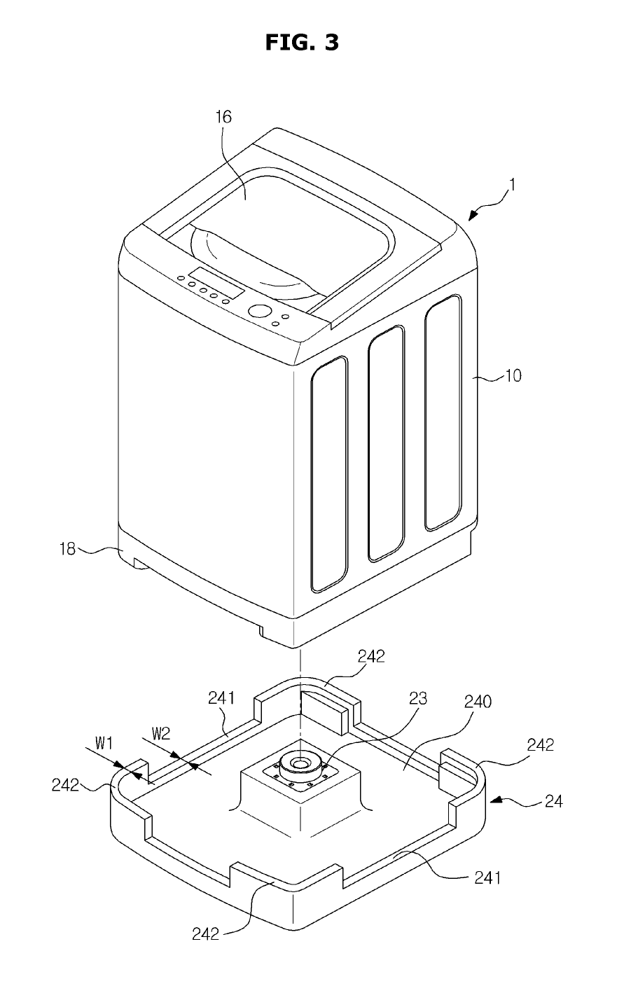

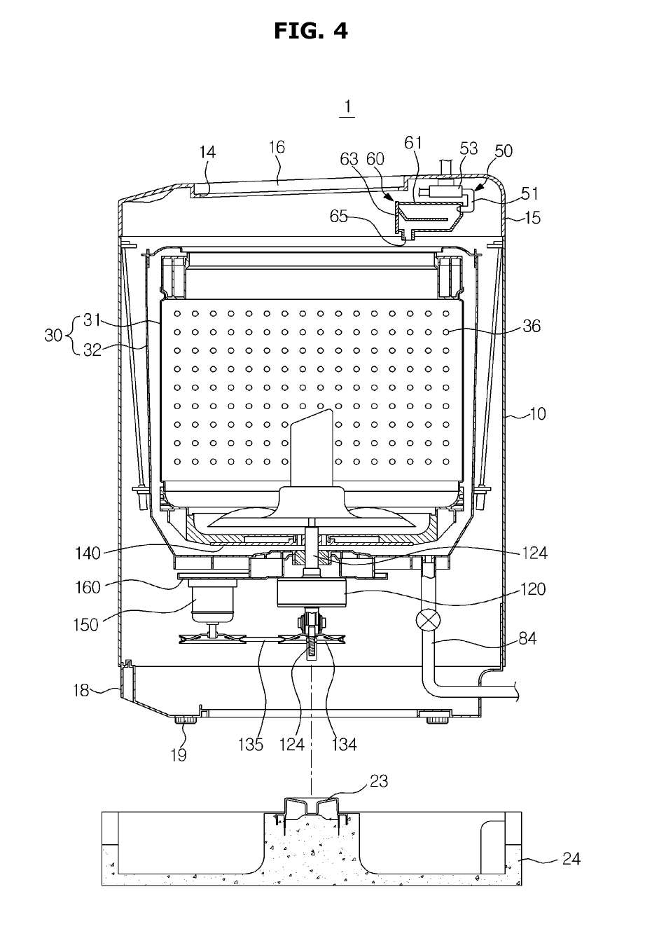

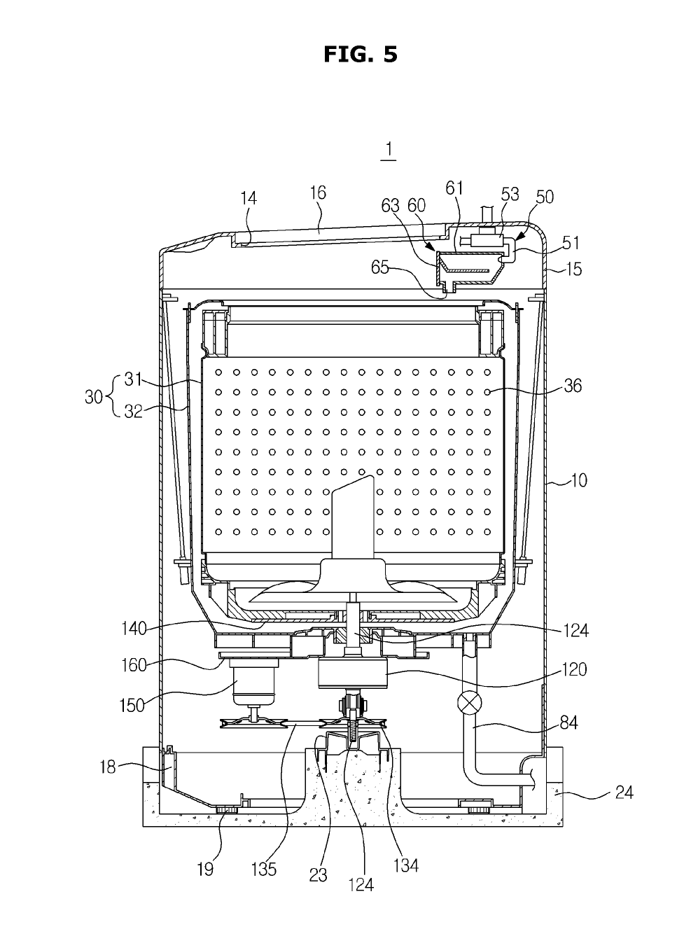

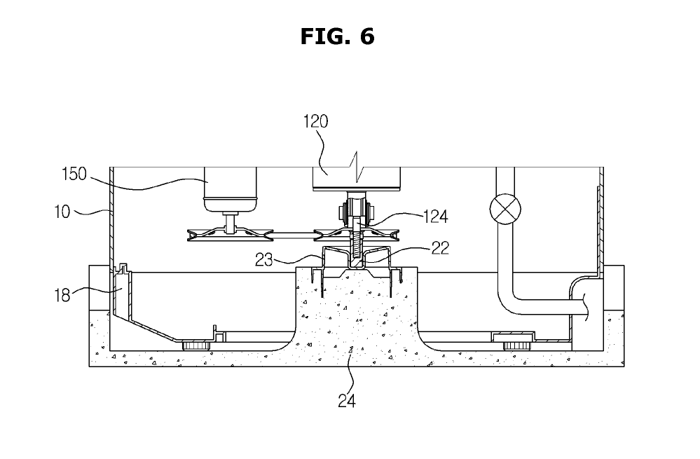

FIG. 3 is a perspective view showing the washing machine according to the and a lower shock-absorbing apparatus, FIG. 4 is a side view showing the washing machine according to the embodiment and the lower shock-absorbing apparatus, FIG. 5 is a side sectional view showing a state in which the lower shock-absorbing apparatus is mounted at the washing machine according to the embodiment, FIG. 6 is a partial side sectional view showing a state in which the lower shock-absorbing apparatus is mounted at the washing machine according to the embodiment.

Referring to FIGS. 3 to 6, a lower cushion 24 may be provided at the lower part of the washing machine 1 when the washing machine 1 is manufactured and packed. The lower cushion 24 may prevent damage to the washing machine 1 which may occur during transportation of the packed washing machine. Meanwhile, an upper cushion (not shown) may be provided at the upper part of the washing tub 30 to absorb shock vertically applied to the washing machine 1 together with the lower cushion 24.

The lower cushion 24 may be manufactured by foaming polypropylene or polystyrene. The lower cushion 24 may be formed to cover the bottom of the washing machine 1. The lower cushion 24 may be formed to cover the bottom of the washing machine 1 and a portion of the side adjacent to the bottom.

For example, the lower cushion 24 may be provided with a location part 240, at which the bottom of the washing machine 1 may be located. The location part 240 may be configured to correspond to the shape of the bottom of the washing machine 1. In a case in which the bottom of the washing machine is quadrangular, the location part 240 may be formed in a quadrangular shape corresponding to the shape of the bottom of the washing machine.

Side supports 241 may protrude from the location part 240. The side supports 241 may protrude upward from the edge of the location part 240 such that the side supports 241 come in surface contact with a portion of the lower outside of the washing machine. Consequently, the lower cushion 24 may be depressed by the height of the side supports 241 such that a portion of the lower part of the washing machine 1 is received in the lower cushion 24.

Corner supports 242 protruding upward from the side supports 241 may be formed at corners of the washing machine 1. A thickness W1 of each of the corner supports 242 may be greater than a thickness W2 of each of the side supports 241. In a case in which the bottom of the washing machine is quadrangular, the corner supports 242 may be much more interfered with. Consequently, the corner supports 242 may more reliably protect the lower corners of the washing machine 1.

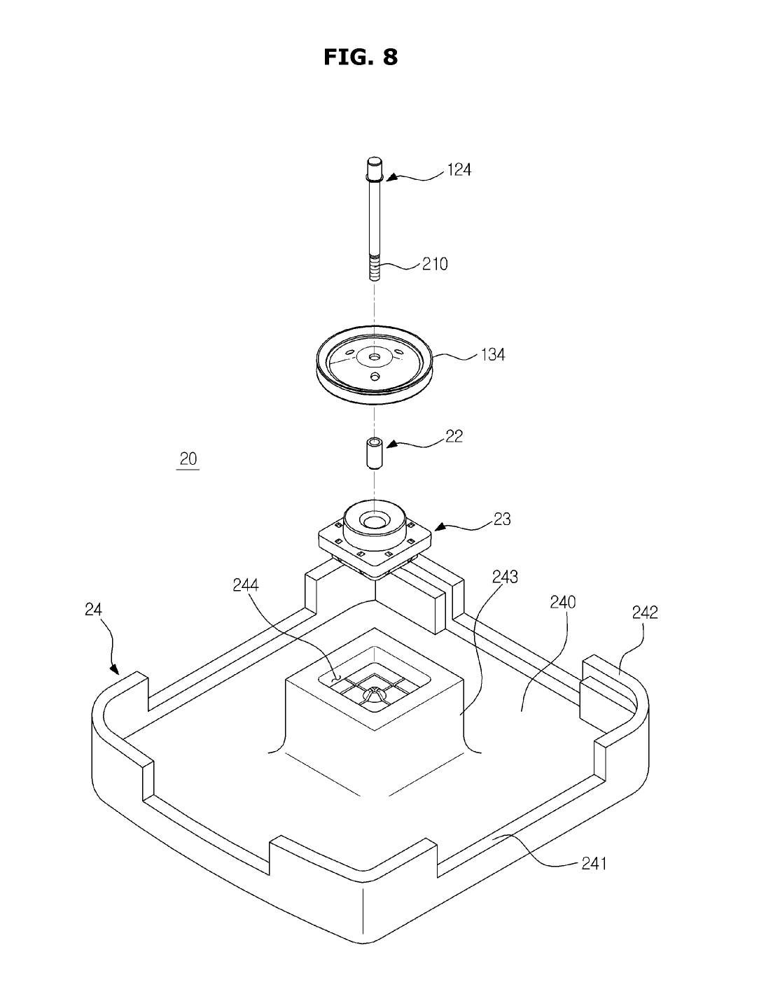

A middle support 243 (see FIG. 8) protruding upward toward the drive unit located at the lower part of the washing machine 1 may be formed at the middle portion of the lower cushion 24. Specifically, the middle support 243 may protrude upward from the location part 240 of the lower cushion 24. The middle support 243 may be integrated with the location part 240, the side supports 241, and the corner supports 242.

The middle support 243 may be provided with a receiving part 244 (see FIG. 8). The drive shaft 124 of the clutch 120 protrudes downward from the clutch 120 by a predetermined length. A portion of the drive shaft 124 may be received in the receiving part 244 of the middle support 243 through a cap 22 and a reinforcement guide 23.

The drive shaft 124 may be received and fixed in the receiving part 244 such that the drive shaft 124 is not separated from the receiving part 244. Specifically, the drive shaft 124 may be received in the receiving part 244 such that the drive shaft 124 is not movable horizontally but is movable vertically.

Since the drive shaft 124 is received and fixed in the receiving part 244, the drive shaft 124 may be prevented from being separated from the receiving part 244 and thus the washing tub 30 may be prevented from moving due to external shock. Since the upper cushion (not shown) is provided at the upper part of the washing tub 30 and the lower cushion 24 is provided below the washing tub 30, shock vertically applied to the washing tub 30 may be absorbed.

The drive shaft 124 of the clutch 120 may protrude more downward than the bottom of the clutch 120 or the drive motor 150.

The drive shaft 124 of the clutch 120 extends downward such that the drive shaft 124 is received and fixed in the receiving part 244. During transportation of the packed washing machine 1, therefore, movement of the washing tub 30 may be prevented and the drive unit located at the lower part of the washing machine 1 may be prevented from being damaged by external shock.

The receiving part 244 may be provided with a reinforcement guide 23. The reinforcement guide 23 may be formed of plastic exhibiting higher strength than the lower cushion 24. Since the reinforcement guide 23 is provided at the receiving part 244, the lower cushion 24 may be prevented from being damaged by the protruding drive shaft 124 during transportation of the packed washing machine 1, thereby guaranteeing protection of the washing machine 1 and shock-absorption.

Hereinafter, a structure in which the drive shaft 124 of the clutch 120 is fixed in the middle support 243 formed at the lower cushion 24 to prevent vertical and horizontal movement of the washing tub 30 will be described with the accompanying drawings.

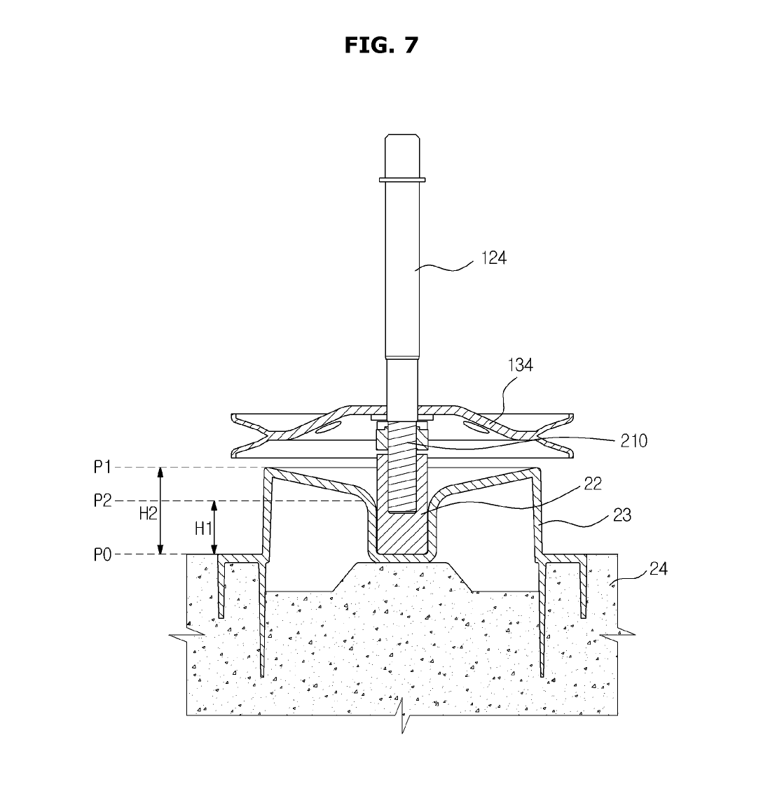

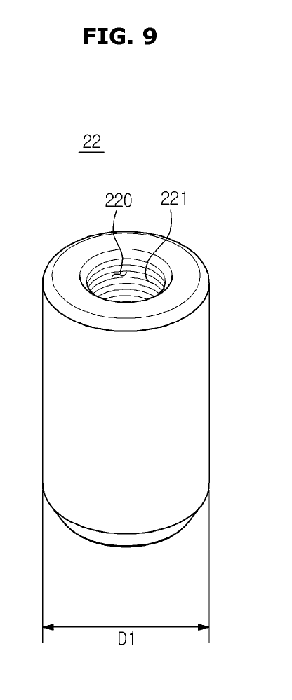

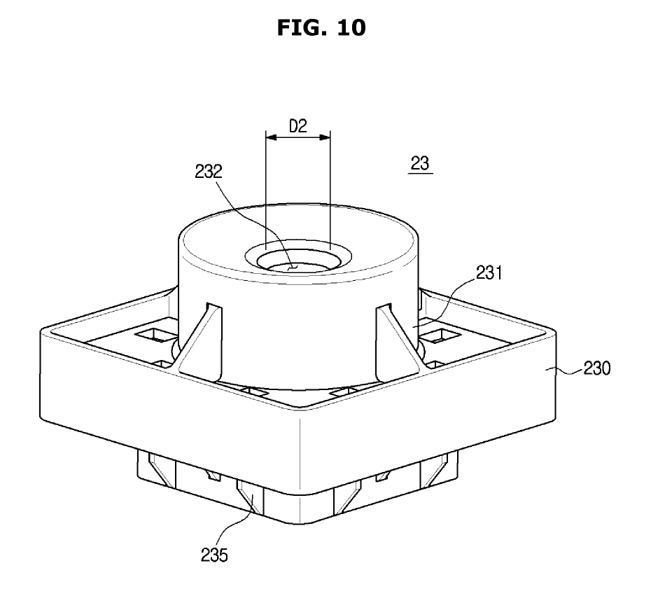

FIG. 7 is a sectional view showing a lower shock-absorbing apparatus for washing machine packing according to an embodiment, FIG. 8 is an exploded perspective view of a movement preventing device according to an embodiment, FIG. 9 is a perspective view showing a cap of the movement preventing device according to the embodiment, and FIG. 10 is a perspective view showing a reinforcement guide of the movement preventing device according to the embodiment.

Referring to FIGS. 7 to 10, the lower shock-absorbing apparatus includes a lower cushion 24 and a movement preventing device 20. The movement preventing device 20 fixes the drive shaft 124 of the clutch 120 provided below the washing tub 30 to prevent movement of the washing tub 30 during transportation of the packed washing machine 1.

The movement preventing device 20 includes a cap 22 and a reinforcement guide 23. The reinforcement guide 23 is provided with a cap receiving part 232, into which the cap 22 may be inserted. The cap 22 is mounted at the lower part of the drive shaft 124 of the clutch 120 such that the cap 22 is inserted into a cap receiving part 232 formed at the reinforcement guide 23 to fix the drive shaft 124 of the clutch 120. Since the drive shaft 124 of the clutch 120 is fixed, horizontal movement of the washing tub 30 is prevented.

A drive shaft insertion hole 220 may be formed at one side of the cap 22. The cap 22 may be formed in the shape of a cylinder, at the central part of which the drive shaft insertion hole 220 is formed. The cap 22 may be manufactured by injection-molding plastic exhibiting higher strength than the lower cushion 24.

The drive shaft 124 of the clutch 120 may be inserted into the drive shaft insertion hole 220 of the cap 22. A thread 210 may be formed at the lower part of the outer circumference of the drive shaft 124 of the clutch 120. A thread 221 corresponding to the thread 210 formed at the drive shaft 124 of the clutch 120 may be formed at the inner circumference of the cap 22, which defines the drive shaft insertion hole 220. The drive shaft 124 of the clutch 120 is inserted into the drive shaft insertion hole 220 formed at the cap 22. The thread 221 formed at the inner circumference of the cap 22 moves along the thread 210 formed at the outer circumference of the drive shaft 124. As a result, the cap 22 may be mounted to the drive shaft 124 of the clutch 120.

The reinforcement guide 23 includes a base 230 and a support 231. The support 231 may protrude upward from the base 230. Since the support 231 protrudes upward from the base 230, a space, into which the cap 22 is inserted, may be provided. The reinforcement guide 23 may be manufactured by injection-molding plastic exhibiting higher strength than the lower cushion 24. The base 230 and the support 231 may integrated by injection molding.

The reinforcement guide 23 may be mounted at the lower cushion 24. Specifically, the base 230 of the reinforcement guide 23 may be mounted at the lower cushion 24. The base 230 may be received in a receiving part 244 formed at a middle support 243 of the lower cushion 24.

At least one fixing rib 235 may protrude from the bottom or the lower side of the base 230. The fixing rib 235 may be forcibly inserted into the inside of the lower cushion 24 defining the receiving part 244. As a result, the reinforcement guide 23 may be fixed in the receiving part 244.

A cap receiving part 232 to receive the cap 22 may be provided at one side of the reinforcement guide 23. Specifically, the cap receiving part 232 may be formed at the support 231 of the reinforcement guide 23. A diameter D2 of the cap receiving part 232 may be equal to a diameter D1 of the cap 22. The diameter D2 of the cap receiving part 232 may be slightly greater than the diameter D1 of the cap 22 such that the cap 22 is easily inserted into the cap receiving part 232. The cap 22 is received in the cap receiving part 232 in a state in which the cap 22 is mounted at the drive shaft 124 of the clutch 120. During transportation of the packed washing machine 1, therefore, the drive shaft 124 of the clutch 120 may be fixed, thereby preventing movement of the drive shaft 124 of the clutch 120.

Between the cap 22 and the inner circumference of the reinforcement guide 23 defining the cap receiving part 232 may be interposed a shock-absorbing member, such as rubber, to absorb shock applied to the cap receiving part 232 by the cap 22. The shock-absorbing member may be attached to the outer circumference of the cap 22 or to the inner circumference of the cap receiving part 232.

The top of the support 231 of the reinforcement guide 23 may be inclined. The top of the support 231 may be inclined such that the height from the top of the base 230 to the top of the support 231 gradually deceases toward the cap receiving part 232.

Specifically, on the assumption that the position of a plane forming the top of the base 230 of the reinforcement guide 23 is P0, the position of an outside corner part of the top of the support 231 is P1, and the position of an inside corner part of the top of the support 231 located on the cap receiving part 232 side is P2, a length H1 from the position P0 of the top of the base 230 to the position P1 of the outside corner part of the top of the support 231 is greater than a length H2 from the position P0 of the top of the base 230 to the position P2 of the inside corner part of the support 231 on the cap receiving part 232 side.

Since the top of the support 231 of the reinforcement guide 23 is inclined such that the height from the top of the base 230 gradually deceases toward the cap receiving part 232 as described above, the cap 22 may be guided along the inclined top of the support 231 by weight of the washing tub 30 and thus easily received in the cap receiving part 232. In addition, since the outside corner part of the top of the support 231 is higher after the cap 22 is received in the cap receiving part 232, the cap 22 may be prevented from being easily separated from the cap receiving part 232.

Since the cap 22 is mounted at the lower end of the drive shaft 124 of the clutch 120 and thus received in the cap receiving part 232 of the reinforcement guide 23 mounted at the lower cushion 24 as described above, the drive shaft 124 of the clutch 120 may be fixed, thereby preventing movement of the drive shaft 124 of the clutch 120. In addition, the washing tub 30, to which the drive shaft 124 is connected, may also be fixed, thereby preventing movement of the washing tub 30. During transportation of the packed washing machine 1, therefore, horizontal movement of the washing tub 30 is prevented.

According to the movement preventing structure as described above, movement of the washing tub 30 is easily prevented. In this embodiment, costs and time necessary to manufacture and assemble a conventional saddle, made of metal, formed to surround the drive motor and clutch may be reduced.

In addition, since the drive shaft 124 of the clutch 120 protrudes more downward than the bottom of the clutch 120 or the drive motor 150 and is fixed by the reinforcement guide 23, movement of the drive motor 150 or the clutch 120 due to external shock may be prevented.

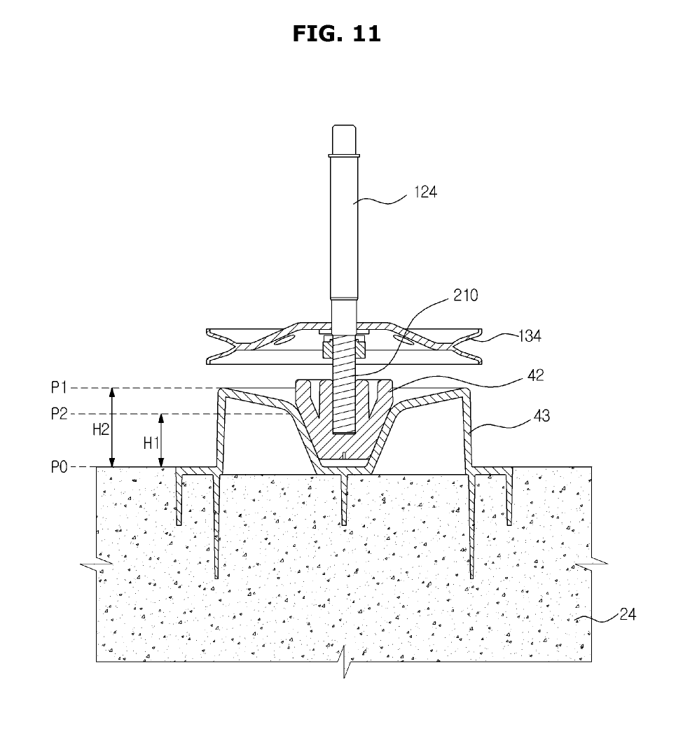

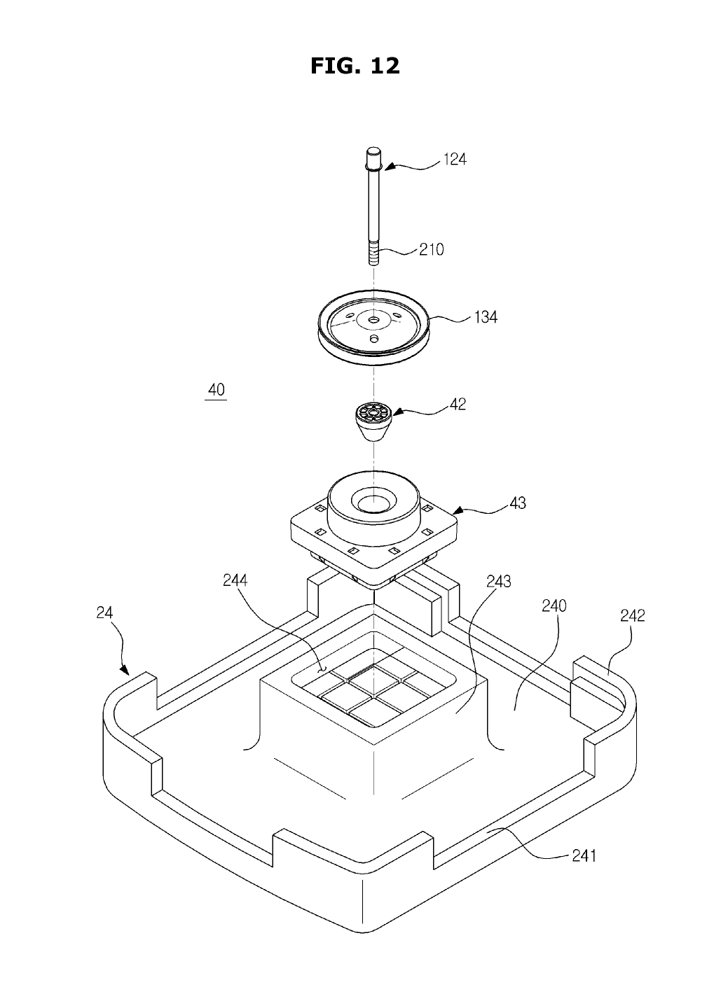

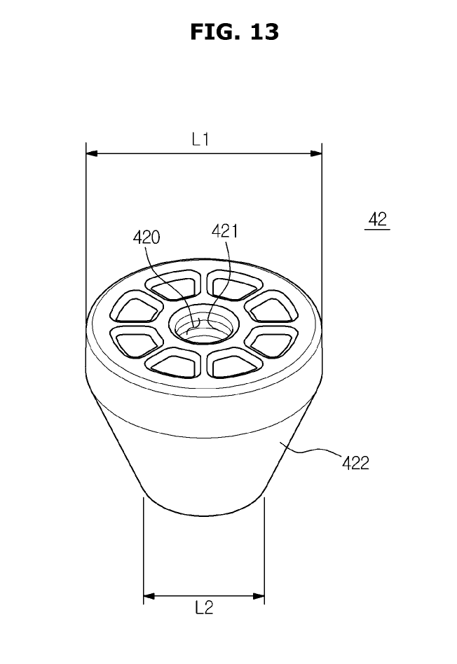

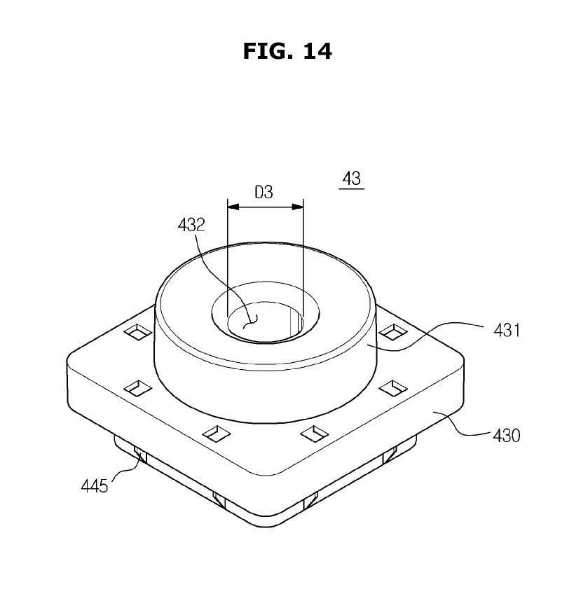

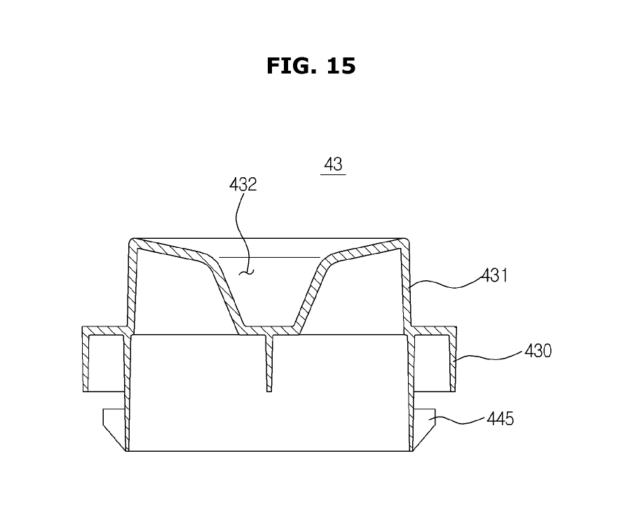

FIG. 11 is a sectional view showing a lower shock-absorbing apparatus for washing machine packing according to an embodiment, FIG. 12 is an exploded perspective view of a movement preventing device according to an embodiment, FIG. 13 is a perspective view showing a cap of the movement preventing device according to the embodiment, FIG. 14 is a perspective view showing a reinforcement guide of the movement preventing device according to the embodiment, and FIG. 15 is a sectional view of a reinforcement guide according to an embodiment.

Referring to FIGS. 11 to 15, the lower shock-absorbing apparatus for washing machine packing includes a lower cushion 24 and a movement preventing device 40. The movement preventing device 40 includes a cap 42 and a reinforcement guide 43. The movement preventing device 40 fixes the drive shaft 124 of the clutch 120 provided below the washing tub 30 to prevent horizontal movement of the washing tub 30 during transportation of the packed washing machine 1.

The movement preventing device 40 includes a cap 42 and a reinforcement guide 43. The reinforcement guide 43 may be mounted at the lower cushion 24 and the cap 42 may be mounted at the drive shaft 124 of the clutch 120. The reinforcement guide 43 may be provided with a cap receiving part 432, into which the cap 42 may be inserted. The cap 42 mounted at the drive shaft 124 may be inserted and fixed in the cap receiving part 432 formed at the reinforcement guide 43. As a result, the drive shaft 124 of the clutch 120 may be fixed.

A drive shaft insertion hole 420 may be formed at one side of the cap 42. The cap 42 may be manufactured by injection-molding plastic exhibiting higher strength than the lower cushion 24.

A thread 421 may be formed at the inner circumference of the cap 42, which defines the drive shaft insertion hole 420. A thread 210 may be formed at the outer circumference of the drive shaft 124 of the clutch 120. The thread 421 formed at the inner circumference of the cap 42 may correspond to the thread 210 formed at the outer circumference of the drive shaft 124. The thread 421 formed at the inner circumference of the cap 42, which defines the drive shaft insertion hole 420, moves along the thread 210 formed at the outer circumference of the drive shaft 124. As a result, the cap 42 may be mounted to the drive shaft 124 of the clutch 120.

The cap 42 may be formed in the shape of a cylinder, at the central part of which the drive shaft insertion hole 420, into which the drive shaft 124 may be inserted, is formed. The outer circumference of the cap 42 may be inclined. Specifically, the outer circumference of the cap 42 may be inclined such that the diameter in section of the cap 42 gradually decreases from the upper end to the lower end of the cap 42. The upper end of the cap 42 means an inlet, through which the drive shaft 124 of the clutch 120 is inserted into the drive shaft insertion hole 420, and the lower end of the cap 42 is the end opposite to the upper end of the cap 42. A diameter L2 in section of the lower end of the cap 42 is less than a diameter L1 in section of the upper end of the cap 42 such that the outer circumference of the cap 42 is inclined.

The reinforcement guide 43 includes a base 430 and a support 431. The support 431 may protrude upward from the base 430. Since the support 431 protrudes upward from the base 430, a space, into which the cap 42 is inserted, may be provided.

The reinforcement guide 23 may be manufactured by injection-molding plastic exhibiting higher strength than the lower cushion 24. The base 430 and the support 431 may integrated by injection molding.

The reinforcement guide 43 may be mounted at the lower cushion 24. Specifically, the base 430 of the reinforcement guide 43 may be mounted at the lower cushion 24. The base 430 may be received in a receiving part 244 formed at a middle support 243 of the lower cushion 24.

At least one fixing rib 445 may protrude from the bottom or the lower side of the base 430. The fixing rib 445 may be forcibly inserted into the inside of the lower cushion 24 defining the receiving part 244. As a result, the reinforcement guide 43 may be fixed in the receiving part 244.

A cap receiving part 432 to receive the cap 42 may be provided at one side of the reinforcement guide 43. Specifically, the cap receiving part 432 may be formed at the support 431 of the reinforcement guide 43. A diameter D3 of the cap receiving part 432 on the inlet side may be greater than a diameter L2 in section of the lowermost end of the cap 42 at least. The inner circumference of the cap receiving part 432 may correspond to the outer circumference of the cap 42. As a result, the cap 42 may be received and fixed in the cap receiving part 432.

When the diameter D3 of the cap receiving part 432 on the inlet side is greater than the diameter L2 of the lower end of the cap 42 as described above, the cap 42 may be more easily inserted into the cap receiving part 432 than when the diameter of the cap receiving part 432 on the inlet side is equal to the diameter of the lower end of the cap 42.

Between the cap 42 and the inner circumference of the reinforcement guide 43 defining the cap receiving part 432 may be interposed a shock-absorbing member, such as rubber. The shock-absorbing member may be attached to the outer circumference of the cap 42 or to the inner circumference of the cap receiving part 432. Since the shock-absorbing member is interposed between the cap 42 and the cap receiving part 432 as described above, shock applied to the clutch 120 through the cap 42 may be absorbed.

The top of the support 431 of the reinforcement guide 43 may be inclined. The top of the support 431 may be inclined such that the height from the top of the base 430 to the top of the support 431 gradually deceases toward the cap receiving part 432.

Specifically, on the assumption that the position of a plane forming the top of the base 430 of the reinforcement guide 43 is P0, the position of an outside corner part of the top of the support 431 is P1, and the position of an inside corner part of the top of the support 431 located on the cap receiving part 432 side is P2, a length H1 from the position P0 of the top of the base 430 to the position P1 of the outside corner part of the top of the support 431 is greater than a length H2 from the position P0 of the top of the base 430 to the position P2 of the inside corner part of the support 231 on the cap receiving part 432 side.

Since the top of the support 431 of the reinforcement guide 43 is inclined such that the height from the top of the base 430 gradually deceases toward the cap receiving part 432 as described above, the cap 42 may be guided along the inclined top of the support 431 and thus easily received in the cap receiving part 432. In addition, since the outside corner part of the top of the support 431 is higher after the cap 42 is received in the cap receiving part 432, the cap 42 may be prevented from being easily separated from the cap receiving part 432.

Since the cap 42 is mounted at the lower end of the drive shaft 124 of the clutch 120 and thus received in the cap receiving part 432 of the reinforcement guide 43 mounted at the lower cushion 24 as described above, the drive shaft 124 of the clutch 120 may be fixed, thereby preventing movement of the drive shaft 124 of the clutch 120. In addition, the washing tub 30, to which the drive shaft 124 is connected, may also be fixed, thereby preventing movement of the washing tub 30. During transportation of the packed washing machine 1, therefore, horizontal movement of the washing tub 30 is prevented.

Furthermore, since the diameter of the cap receiving part 432 is greater than that of the lower end of the cap 42 and the top of the support 431 is inclined such that the height of the top of the support 431 gradually deceases toward the cap receiving part 432, the cap 42 may be easily inserted into the cap receiving part 432 by sliding.

In the above, the cap has been described as being mounted at the drive shaft of the clutch. Alternatively, the cap may be mounted at various bar-type structures, such as the drive shaft of the drive motor, connected to the washing tub and protruding downward from the washing tub. The cap may be received in the reinforcement guide provided at the lower cushion to prevent movement of the washing tub during transportation of the packed washing machine.

In the lower shock-absorbing apparatus for washing machine packing including the movement preventing structure according to the embodiment of the present invention as described above, costs necessary to manufacture the movement preventing structure and time necessary to manufacture and assemble the movement preventing structure may be reduced as compared with in the conventional lower shock-absorbing apparatus for washing machine packing.

As is apparent from the above description, embodiments provide a lower shock-absorbing apparatus for washing machine packing, wherein a cap, which is inserted into the lower shock-absorbing apparatus, is mounted and fixed to a drive shaft of a drive unit provided below a washing tub, thereby preventing movement of the washing tub during transportation of the packed washing machine.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A lower shock-absorbing apparatus for washing machine packing comprising:
a cap mounted at a drive shaft mounted to a washing tub to rotate the washing tub;
a reinforcement guide to receive the cap; and
a lower cushion disposed below the washing tub to absorb shock applied to the washing tub and to receive the reinforcement guide.

2. The lower shock-absorbing apparatus according to claim 1, wherein the reinforcement guide is provided with a cap receiving part corresponding to an external shape of the cap and the cap is received in the cap receiving part such that the washing tub is fixed, thereby preventing movement of the washing tub.

3. The lower shock-absorbing apparatus according to claim 1, wherein the reinforcement guide comprises:
a base mounted at the lower cushion; and
a support protruding upward from the base, the support being provided with a cap receiving part to receive the cap.

4. The lower shock-absorbing apparatus according to claim 3, wherein a height from a top of the base to a top of the support gradually deceases from an outer edge of the support to an inner edge of the support on the cap receiving part side such that the cap slides along a top of the reinforcement guide by weight of the washing tub and is inserted into the cap receiving part.

5. The lower shock-absorbing apparatus according to claim 3, wherein the cap is provided at one side thereof with a drive shaft insertion hole, into which the drive shaft is inserted.

6. The lower shock-absorbing apparatus according to claim 5, wherein the cap is provided at an inside thereof defining the drive shaft insertion hole with a thread and the thread formed at the inside of the cap moves along a thread formed at an outside of the drive shaft such that the cap is mounted to the drive shaft.

7. The lower shock-absorbing apparatus according to claim 6, wherein the cap has an inclined outside.

8. The lower shock-absorbing apparatus according to claim 7, wherein the cap is configured such that a diameter in section of a lower end of the cap is less than a diameter in section of an upper end of the cap.

9. The lower shock-absorbing apparatus according to claim 8, wherein the cap receiving part formed at the reinforcement guide is configured such that a diameter of the cap receiving part on an inlet side is greater than a diameter of a lower end of the cap receiving part so as to correspond to an external shape of the cap.

10. The lower shock-absorbing apparatus according to claim 6, wherein the cap is formed in a cylindrical shape and the cylindrical cap is received in the cap receiving part.

11. The lower shock-absorbing apparatus according to claim 1, wherein the lower cushion is manufactured by foaming polystyrene or polypropylene.

12. The lower shock-absorbing apparatus according to claim 1, wherein the cap or the reinforcement guide is manufactured by injection-molding plastic.

13. The lower shock-absorbing apparatus according to claim 1, wherein the lower cushion comprises a location part, at which a bottom of the washing machine is located, and a side support protruding upward from an edge of the location part such that the side support comes in surface contact with a portion of a lower outside of the washing machine.

14. The lower shock-absorbing apparatus according to claim 13, wherein the location part is provided with a middle support protruding upward and the middle support is provided with a receiving part to receive the reinforcement guide.

15. The lower shock-absorbing apparatus according to claim 1, wherein the reinforcement guide is provided at an outside thereof with a fixing rib and the fixing rib is forcibly inserted into the lower cushion such that the reinforcement guide is mounted at the lower cushion.

16. A lower shock-absorbing apparatus for washing machine packing comprising:
a cap mounted at an end of a drive shaft connected to a washing tub;
a reinforcement guide having a cap receiving part corresponding to a shape of the cap; and
a lower cushion to receive the reinforcement guide, wherein
the cap is formed in a cylindrical shape in which a diameter in section of an upper end of the cap is greater than a diameter in section of a lower end of the cap and the cap is received in the cap receiving part to prevent movement of the washing tub.

17. The lower shock-absorbing apparatus according to claim 16, wherein the reinforcement guide has an inclined top such that the cap slides along the inclined top of the reinforcement guide and is inserted into the cap receiving part.

18. The lower shock-absorbing apparatus according to claim 16, wherein the reinforcement guide is provided at an outside thereof with a plurality of fixing ribs and the fixing ribs are forcibly inserted into the lower cushion such that the reinforcement guide is mounted at the lower cushion.

19. The lower shock-absorbing apparatus according to claim 16, further comprising a shock-absorbing member disposed between the cap and an inside of the reinforcement guide defining the cap receiving part.

20. The lower shock-absorbing apparatus according to claim 16, wherein the lower cushion is provided with a middle support protruding upward and the reinforcement guide is fixed to the middle support such that shock applied to a lower part of the washing tub is transmitted to the lower cushion via the drive shaft, the cap, and the reinforcement guide to absorb the shock applied to the washing tub.

21. A lower shock-absorbing apparatus for washing machine packing comprising:
a cushion comprising a first material to receive the bottom of a washing machine;
a center support protruding from the cushion;
a reinforcing guide comprising a second material different from the first material mounted on top of the center support;
a cap made of the second material mounted on a drive shaft of the washing machine to be received within the reinforcing guide.

22. The lower shock-absorbing apparatus according to claim 21, wherein the cushion is manufactured by foaming polystyrene or polypropylene.

23. The lower shock-absorbing apparatus according to claim 21, wherein the cap and the reinforcement guide is manufactured by injection-molding plastic.

24. The lower shock-absorbing apparatus according to claim 21, wherein the reinforcement guide comprises:
a base mounted at the cushion; and
a support protruding upward from the base, the support being provided with a cap receiving part to receive the cap.
